(19) United States
(12) Patent Application Publication
(10) Pub. No.: US 2025/0104057 A1
(43) Pub. Date: Mar. 27, 2025

(54) FUTURE CONDITIONAL BLOCKCHAIN TRANSACTION TECHNIQUES

(71) Applicant: Kirobo, Ltd., Tel Aviv (IL)

(72) Inventor: Tal ASA, Tel Aviv (IL)

(73) Assignee: Kirobo, Ltd., Tel Aviv (IL)

(21) Appl. No.: 18/975,753

(22) Filed: Dec. 10, 2024

Related U.S. Application Data
(63) Continuation of application No. PCT/IB2023/056276, filed on Jun. 16, 2023.
(60) Provisional application No. 63/366,568, filed on Jun. 17, 2022.

(51) Int. Cl. G06Q 20/38; G06Q 20/40; H04L 9/32

(52) U.S. Cl. CPC G06Q 20/3825; G06Q 20/401; H04L 9/3247

(57) ABSTRACT

Techniques for providing and executing future conditional transactions. A future conditional transaction (FCT) is defined in a FCT message including conditions, actions to be executed when the conditions are met, and limitations on uploading the FCT to a blockchain. The FCT message is stored on a temporary storage that is accessible to one or more activator systems. An FCT is created based on the FCT message and uploaded to a blockchain by one of the activator systems in accordance with the limitations defined in the FCT message. Once uploaded to the blockchain, the FCT message conditions are checked via a first FCT engine smart contract. If the conditions are met, the FCT engine smart contract commands one or more on-chain wallet smart contracts to execute the actions of the FCT via one or more records smart contracts configured to store transaction data reflecting the actions.

### CROSS-REFERENCE TO RELATED APPLICATIONS

This application is a continuation of International Application No. PCT/IB2023/056276, filed on Jun. 16, 2023, now pending, which claims the benefit of U.S. Provisional Patent Application No. 63/366,568 filed on Jun. 17, 2022. This application also relates to U.S. patent application Ser. No. 16/901,726 filed on Jun. 15, 2020, now pending.

The contents of the above-referenced applications are hereby incorporated by reference.

### TECHNICAL FIELD

The present disclosure relates generally to blockchain transactions, and more specifically to conditionally recording transactions on the blockchain.

### BACKGROUND

Some existing blockchain solutions provide benefits in securing transactions to be recorded on the blockchain, but require that secured transactions be conducted immediately and with predefined values in order to be successful. Existing solutions do not, by default, allow users to initiate future transactions to be uploaded to the blockchain at a later time. Instead, such future transactions can only be realized by a user writing their own smart contract, a computer program configured to enforce one or more requirements of the transaction, and embedding the smart contract into the transaction. Further, the transaction with the smart contract embedded therein must either be uploaded manually or the user would need to write a special script configured to control when the transaction is uploaded in order to ensure that the transaction is uploaded to the blockchain at the exact time desired by the user.

Additionally, existing solutions are limited with respect to platforms. Several different blockchain platforms exist, and these platforms utilize different proprietary software and application programming interfaces (APIs). Smart contracts written in a programming language and using APIs call designed with a specific blockchain platform in mind do not work with others. This restricts the kinds of conditions which can be effectively placed on transactions.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for executing future conditional blockchain transactions. The method comprises: creating a future conditional transaction (FCT) based on a FCT message, wherein the FCT message includes at least one condition, at least one action to be executed when the at least one condition is met, and at least one limitation on uploading the FCT to a blockchain, wherein the blockchain has stored thereon a first smart contract and a plurality of second smart contracts, wherein each of the plurality of second smart contracts includes instructions for implementing at least one wallet function; and uploading the FCT to the blockchain based on the at least one limitation, wherein the first smart contract is configured to determine that the at least one condition is met and to execute the at least one action via the plurality of second smart contracts when the at least one condition is met.

Certain embodiments disclosed herein also include a non-transitory computer readable medium having stored thereon causing a processing circuitry to execute a process, the process comprising: creating a future conditional transaction (FCT) based on a FCT message, wherein the FCT message includes at least one condition, at least one action to be executed when the at least one condition is met, and at least one limitation on uploading the FCT to a blockchain, wherein the blockchain has stored thereon a first smart contract and a plurality of second smart contracts, wherein each of the plurality of second smart contracts includes instructions for implementing at least one wallet function; and uploading the FCT to the blockchain based on the at least one limitation, wherein the first smart contract is configured to determine that the at least one condition is met and to execute the at least one action via the plurality of second smart contracts when the at least one condition is met.

Certain embodiments disclosed herein also include a system for executing future conditional blockchain transactions. The system comprises: a processing circuitry; and a memory, the memory containing instructions that, when executed by the processing circuitry, configure the system to: create a future conditional transaction (FCT) based on a FCT message, wherein the FCT message includes at least one condition, at least one action to be executed when the at least one condition is met, and at least one limitation on uploading the FCT to a blockchain, wherein the blockchain has stored thereon a first smart contract and a plurality of second smart contracts, wherein each of the plurality of second smart contracts includes instructions for implementing at least one wallet function; and upload the FCT to the blockchain based on the at least one limitation, wherein the first smart contract is configured to determine that the at least one condition is met and to execute the at least one action via the plurality of second smart contracts when the at least one condition is met.

Certain embodiments disclosed herein include the method, non-transitory computer readable medium, or system noted above or below, wherein the FCT message is uploaded to the blockchain, wherein the first smart contract is configured to read the FCT message on the blockchain.

Certain embodiments disclosed herein include the method, non-transitory computer readable medium, or system noted above or below, wherein the first smart contract is further configured to validate a signature of the FCT message.

Certain embodiments disclosed herein include the method, non-transitory computer readable medium, or system noted above or below, wherein the first smart contract is further configured to assign at least one second smart contract of the plurality of second smart contracts to the FCT.

Certain embodiments disclosed herein include the method, non-transitory computer readable medium, or system noted above or below, wherein the at least one second smart contract assigned to the FCT is configured to record at least one transaction on the blockchain with respect to the FCT.

Certain embodiments disclosed herein include the method, non-transitory computer readable medium, or system noted above or below, wherein the at least one action is defined with respect to at least one variable, wherein the at least one action is executed based on a value of the at least one variable.

Certain embodiments disclosed herein include the method, non-transitory computer readable medium, or system noted above or below, wherein the FCT is a first FCT, wherein the first FCT defines logic linking the first FCT to a second FCT such that the first FCT is conditional upon the second FCT.

Certain embodiments disclosed herein include the method, non-transitory computer readable medium, or system noted above or below, wherein the first FCT is a first sub-FCT of a plurality of sub-FCTs of the second FCT, wherein the second FCT has at least one condition, wherein the plurality of sub-FCTs are executed simultaneously when the at least one condition of the second FCT is met.

Certain embodiments disclosed herein include the method, non-transitory computer readable medium, or system noted above or below, wherein the plurality of sub-FCTs are translated into a single native transaction, wherein the single native transaction is recorded on the blockchain.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a flow diagram utilized to describe various disclosed embodiments.

FIG. 2 is a data flow diagram utilized to describe various disclosed embodiments.

FIG. 3 is a flowchart illustrating a method for creating a future conditional transaction according to an embodiment.

FIG. 4 is a flowchart illustrating a method for activating a future conditional transaction according to an embodiment.

FIG. 5 is a flowchart illustrating a method for executing a future conditional transaction according to an embodiment.

FIG. 6 is a schematic diagram of a hardware layer utilized according to an embodiment.

### DETAILED DESCRIPTION

The various disclosed embodiments include methods and systems for realizing future conditional blockchain transactions. More specifically, the disclosed embodiments provide techniques for uploading of a conditional transaction to a blockchain in order to enable uploading of the conditional transaction at a future time that occurs after the initial time at which the parameters of the FCT are defined. In other words, the disclosed embodiments provide systems and techniques that allow for controlling the timing of uploading such conditional transactions at a later point in time.

To this end, limitations on uploading messages representing future conditional transactions are checked by one or more activators running a FCT engine smart contract. The limitations define conditions for uploading a future conditional transaction to a blockchain such that the future conditional transaction is uploaded to the blockchain when its limitations, or limits, are met. When the conditions for a future conditional transaction are met, the message representing the future conditional transaction is retrieved and uploaded to a blockchain for enforcement.

In an embodiment, enforcement of the future conditional transactions is realized via multiple smart contracts stored on the blockchain such as, but not limited to, a first FCT engine smart contract configured to analyze limitations on uploading future conditional transactions indicated in FCT messages in order to upload future conditional transactions when their respective limitations are met, a set of second on-chain wallet smart contracts configured with wallet functionality in order to record transactions related to future conditional transactions, a third factory smart contract configured to create and manage on-chain wallet smart contracts on the blockchain, and the like. Each on-chain wallet smart contract is an on-chain wallet having permissions to request recording of transactions, for example, via one or more fourth records smart contracts stored on the blockchain, thereby executing actions of the future conditional transaction.

In accordance with various disclosed embodiments, future conditional transactions (FCTs) may be linked in order to create a complex multi-FCT transaction (also referred to as a mega FCT) in which uploading of FCTs among a given mega FCT are conditioned upon the same or interrelated conditions, and the FCTs of a mega FCT may optionally be recorded simultaneously. The multi-FCT transactions may be assigned a priority used to decide the order of execution of the FCTs contained therein.

The disclosed embodiments may be utilized to define conditions for checking by smart contracts without requiring explicitly programming conditions in different programming languages of other blockchain platforms and, instead, may be realized by coding messages according to a unified format that is not specific to any cryptocurrency, NFT, or other platforms utilizing blockchains to record transactions. To this end, FCT messages may be defined in a blockchain platform-agnostic format that is universal to various publicly or privately available blockchains.

In accordance with various disclosed embodiments, the FCT engine smart contract and the on-chain wallet smart contracts act as a secondary smart contract layer on a blockchain applied over a primary smart contract layer including records smart contracts responsible for recording and accessing transaction data on the blockchain. A future conditional transaction (FCT) is defined using one or more predetermined variables associated with the secondary smart contract layer. In accordance with various disclosed embodiments, the predetermined variables are non-blockchain platform specific, i.e., they are universal variables in a unified FCT format that are not proprietary or otherwise unique to a specific blockchain platform.

Accordingly, the disclosed embodiments allow users to seamlessly define conditions for smart contracts used to implement future conditional transactions without explicitly programming the smart contracts to include calls in programming languages or using APIs that are specific to any particular blockchain platform. This allows users to define the parameters of their own smart contracts without requiring blockchain platform-specific programming knowledge. Various disclosed embodiments further provide techniques which account for potential variations in circumstances checked using conditions and limitations which ensure that FCTs do not fail simply because certain circumstances from the time of initial definition of the FCT have changed over time.

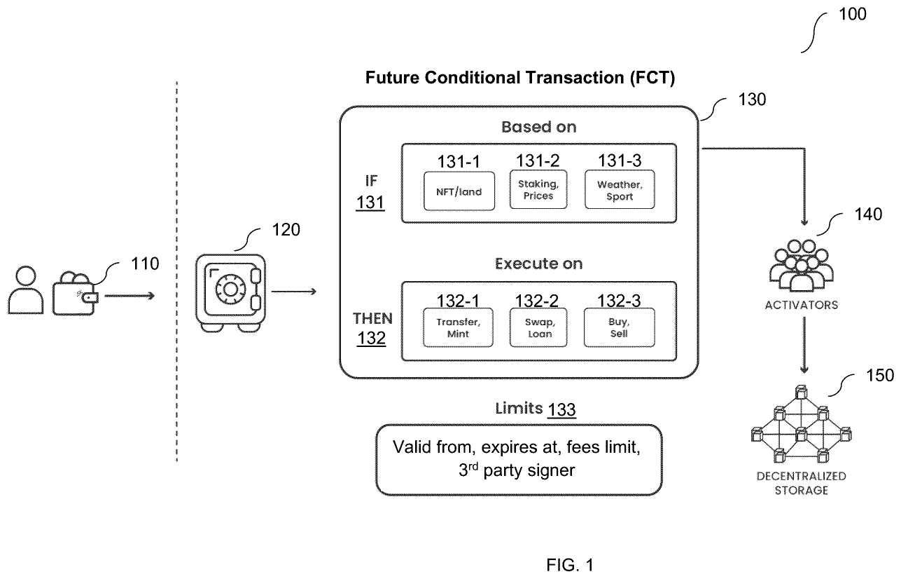

FIG. 1 is a flow diagram 100 utilized to describe various disclosed embodiments. The flow diagram 100 illustrates the logical entities communicating in a process beginning with creation of a future conditional transaction (FCT) through recording of the FCT on one or more blockchain platforms.

A user of a wallet 110 defines a FCT (e.g., by creating a FCT message defining conditions, actions, and limits on uploading the FCT), which is uploaded to a blockchain on which a vault 120 is stored. The FCT is a transaction to be recorded on a blockchain at a future time as compared to when the FCT is initially defined. The future time may be, but is not limited to, a specific date, within a range of potential dates, a specific time, within a range of potential times, indefinitely (e.g., until the conditions are met), until the FCT is cancelled, and the like. The FCT is defined via one or more unified FCT variables that are not blockchain platform-specific. In other words, in accordance with various disclosed embodiments, the unified FCT variables do not need to be expressed in a manner that is compatible with any particular blockchain platform.

The vault 120 includes a set of on-chain wallets (not separately depicted) stored on a blockchain (also not separately depicted). Each of the on-chain wallets is a smart contract stored on the blockchain. Consequently, each on-chain wallet is a decentralized wallet, i.e., each on-chain wallet is distributed across a network of nodes. A smart contract is a computer program stored on a blockchain that includes instructions to be executed when one or more conditions are met.

The vault 120 is assigned to a FCT 130 stored on the same blockchain and including parameters such as conditions (“IF”) 131, actions to be executed (“THEN”) 132, and limitations (“Limits”) on uploading the FCT 133. The on-chain wallet smart contracts of the vault 120 is configured to execute transactions when the conditions 131 are met by performing the actions 132, subject to the limitations 133. The conditions 131 may be defined with respect to one or more blockchain platforms and/or other platforms such as a metaverse platform condition 131-1, a decentralized exchange (DEX) platform condition 131-2, and an external factor condition 131-3. The conditions 131 may include conditions requiring matching, greater than or less than comparisons, combinations thereof, and the like.

The metaverse platform conditions 131-1 may include conditions related to ownership of digital items or otherwise related to the status of a specific portion of an at least partially virtual environment. Non-limiting examples of metaverse platform conditions 131-1 are requirements that a transacting party own a particular non-fungible token (NFT) or piece of virtual land.

The DEX platform conditions 131-2 include conditions related to one or more digital currency marketplaces (e.g., cryptocurrency marketplaces). Non-limiting examples of DEX platform conditions 131-2 may include requirements on staking or prices.

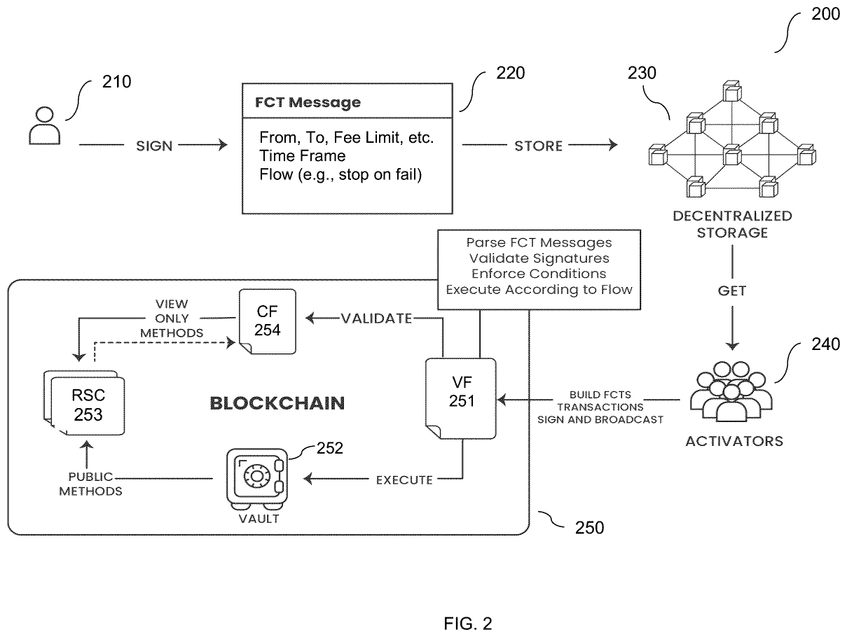

The external factor conditions 131-3 include conditions related to the real world or otherwise to a non-virtual environment which are indicated by data which may be stored on a blockchain (e.g., the blockchain 250, FIG. 2) such that they are accessible to a vaults factory stored on that blockchain. Non-limiting examples of external factor conditions 131-3 may be requirements related to weather (e.g., weather is sunny, weather is not snowy, etc.), to sports (e.g., to outcomes of sporting events), or any other conditions related to activities occurring outside the vaults, blockchains, decentralized storages, etc.

Other conditions which are not shown may be equally utilized without departing from the scope of the disclosure. In an embodiment, the conditions of a given FCT may include one or more FCT-dependent conditions which are defined with respect to execution of one or more other FCTs. In other words, in such an embodiment, execution of one FCT may be entirely conditional on another FCT, or the execution of the FCT may be otherwise affected by the outcome of executing another FCT.

The actions 132 are defined with respect to actions which may be realized by executing computer programs and, in particular, smart contracts. To this end, the actions 132 may include, but are not limited to, token-based actions 132-1, DEX-based actions 132-2, and metaverse actions 132-3. The token-based actions 132-1 include actions performed with respect to tokens such as NFTs and may include, but are not limited to, transferring a NFT, minting (i.e., creating a new) NFT, and the like. The DEX-based actions 132-2 include actions performed via a decentralized exchange such as, but not limited to, swapping currencies, loaning funds, and the like. The metaverse actions 132-2 may include, but are not limited to, buying an item in a virtual environment (e.g., buying a NFT or a piece of virtual land), selling such an item, and the like.

The limits 133 may include other conditions on uploading the FCT 130 such as, but not limited to, a start date for validity of the FCT, an expiration date (end date) for enforcing the FCT, transaction expense limits (e.g., a maximum cost of blockchain-based transactions such as a Gas cost for Ethereum at the time when the FCTs would be executed by recording transactions on one or more blockchains), a requirement for a third party signer (i.e., a user other than one of the parties to the FCT), combinations thereof, and the like. In accordance with various disclosed embodiments, the limits 133 are defined such that the FCT is to be recorded at a future time as compared to when the FCT is defined. In other words, the FCT is not necessarily recorded on the blockchain immediately upon being defined.

The FCT 130 is accessible to one or more activators 140 via a storage such as a decentralized storage 150. The activators 140 may execute or otherwise be realized via one or more FCT engine smart contracts. More specifically, information about the parameters of the FCT 130 are provided to the activators 140 such that the activators 140 can check the limits 133. When the conditions defined by the limits 133 are met, the activators 140 may be configured to access the decentralized storage 150 in order to retrieve the corresponding FCT message for the FCT 130. The activators 140 then generate a FCT using the FCT message and upload the FCT to a blockchain (not shown in FIG. 1).

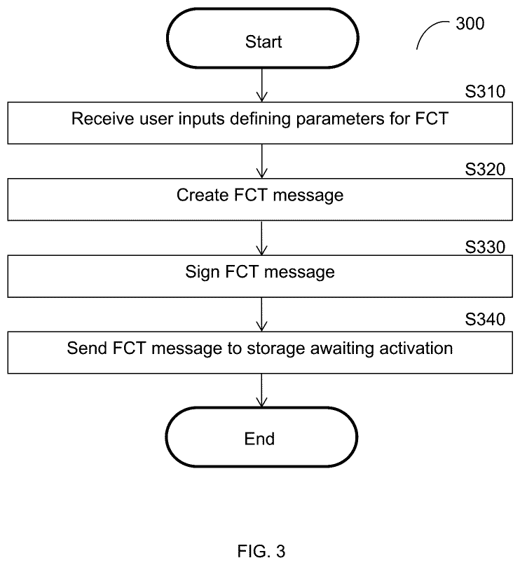

Activities vis-à-vis a blockchain are now described further with respect to FIG. 2. FIG. 2 is a data flow diagram 200 utilized to describe various disclosed embodiments. The flow diagram 200 illustrates the process of creating and recording an FCT in more detail vis-à-vis the FCT. A user 210 creates a FCT message 220 using one or more predetermined variables in a unified FCT format. An example method for creating an FCT message is described further below with respect to FIG. 3.

The FCT message 220 defines execution parameters for a FCT such as, but not limited to, conditions defined with respect to data stored on one or more platforms (e.g., on one or more blockchains, in centralized databases, combinations thereof, etc.), actions to be executed when the conditions are met, limits on recording the FCT (e.g., temporal limitations on when the FCT can be uploaded to a blockchain, external requirements on uploading the FCT, etc.), combinations thereof, and the like. The external requirements on uploading the FCT may include, but are not limited to, conditions on transaction fees for recording the FCT on a blockchain (e.g., a maximum transaction fee price such that the FCT cannot be uploaded if the current transaction fee price at the would be time of uploading is above the maximum allowed transaction fee price), external conditions (e.g., a condition requiring a third party signer also sign the FCT before uploading), both, and the like.

Moreover, in some embodiments, the conditions on uploading the FCT related to third party signers may support multi-signature (multi-sig) features that account for potential future variations in availability of signers. When an FCT requires multiple signatures from third party signers, requirements on third party signers may be defined to require a certain number or proportion (e.g., 3 out of 5) third party signers in order for the FCT to be uploaded to and recorded on the blockchain. Since the FCTs may be uploaded at a later time as compared to when they are defined, providing signer requirements that allow for variations in the availability of certain signers without voiding the FCTs allows for ensuring that FCTs can be successfully executed even as the availability of particular signers changes over time.

In an example implementation, the FCT message 220 may be written in a human-readable format. Further, in accordance with various disclosed embodiments, the FCT message 220 is written such that it can be transformed for a standard function call when uploaded to a blockchain. To this end, the FCT message 220 may be written in a standard such as, but not limited to, the Ethereum EIP 712 standard. It should be noted that other standards may be utilized for composing the FCT message 220 without departing from the scope of the disclosure.

As a non-limiting example, a portion of a particular FCT message may appear as follows:

method_interface: ‘transfer(address,uint256)’,
method_params_offset: 0x60,
method_params_length: 0x40,
to: ‘0x74bEdF05d528F6F2409b326eDdC86793acBCC6CB’,
amount: ‘23152423’

### EXAMPLE 1

As can be seen in Example 1, the FCT message is in a human-readable format that allows the user signing the transaction to see which functions are being called and their respective values. A system can parse the call in the FCT message stored on the blockchain and generate the machine bytes needed to execute the call.

The following is another non-limiting example for a transfer FCT message:

call_address: <token address>
cryptocurrency_value: 0
...
view_only:false
method_interface - “transfer”
to - <address>
amount - <token amount>

### EXAMPLE 2

The user 210 signs the FCT message 220 with a unique signature and sends the signed FCT message 220 to a storage such as a decentralized storage 230. In various disclosed embodiments, FCTs uploaded by various users (not shown), multiple FCTs uploaded by the same user, or both, may be stored in the decentralized storage 230 while awaiting execution.

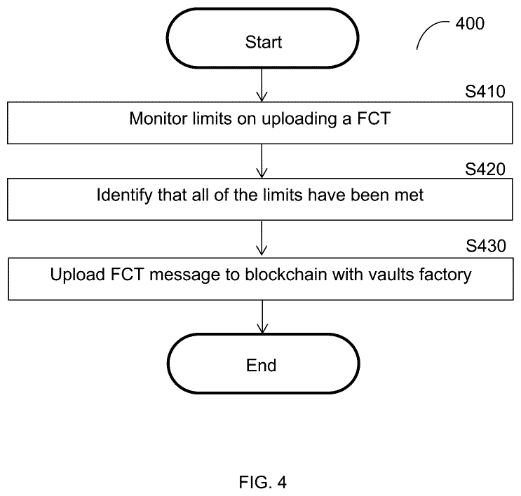

The FCT message 220 is stored on the decentralized storage 230 at least until all of its conditions for uploading are met or the FCT message 220 expires. When the conditions for uploading the FCT defined as limits (e.g., the limits 133, FIG. 1) of the FCT message 220 have been met, one of the activators 240 is configured to activate the FCT defined by the FCT message 220. Activating the FCT at least includes uploading the FCT message 220 to a blockchain such as the blockchain 250. In an embodiment, the FCT message 220 is uploaded to the blockchain 250 immediately upon all of its conditions for upload being met. An example method for activating a FCT is described further below with respect to FIG. 4. In an embodiment, each of the activators 240 is a system configured to perform part or all of the process described with respect to FIG. 4. In a further embodiment, the activators 240 store thereon or otherwise have access to a FCT engine smart contract containing instructions for performing at least a portion of the process described with respect to FIG. 4.

It should be noted that the activators 240 are depicted as separate systems from the decentralized storage 230, but that the activators 240 may be integrated in or otherwise with the decentralized storage 230 in the same system(s) without departing from the scope of the disclosure. In some embodiments, the activators 240 may store FCT messages such as the FCT message 220 in local storages (i.e., storages in the activators 240 or otherwise locally accessible to the activators 240) in order to improve efficiency of accessing the FCT messages. This improved efficiency may be useful, for example, when FCT messages are being uploaded to the blockchain 250 frequently or in order to minimize the amount of time between all of the conditions of a FCT being met and uploading of the FCT message for that FCT to the blockchain.

Once uploaded to the blockchain 250, the FCT message 220 can be parsed and translated into machine-readable instructions for execution, thereby executing the FCT message 220. The execution of the FCT message 220 can be realized via a first FCT engine smart contract 251 and a set of second on-chain wallet smart contracts (also referred to as on-chain wallets) 252. In an embodiment, the smart contracts 252 are a set of on-chain wallets. In other words, the on-chain wallet smart contracts 252 include wallets stored on the blockchain 250.

Each of the FCT engine smart contract 251 and the on-chain wallets is a smart contract stored on the blockchain 250. Consequently, each on-chain wallet is a decentralized wallet, i.e., each on-chain wallet is distributed across a network of nodes. A smart contract is a computer program stored on a blockchain that includes instructions to be executed when one or more conditions are met.

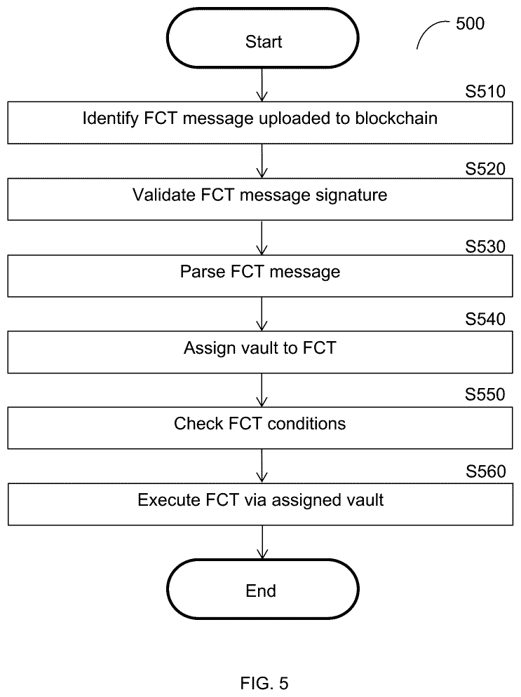

In an embodiment, the FCT engine smart contract 251 is a centralized smart contract including instructions for performing functions such as, but not limited to, generating vaults such as the vault 252, managing available vaults, parsing and executing FCTs using respective vaults, combinations thereof, and the like. To this end, the FCT engine smart contract 251 may be assigned privileges to execute actions with respect to the on-chain wallets 252. In a further embodiment, the FCT engine smart contract 251 is further configured to validate FCT signatures (e.g., a signature of the signed FCT message 220). The FCT engine smart contract 251 is configured to read the FCT message 220 on the blockchain, verify the signature of the FCT message 220, and proceed to execute the FCT represented by the FCT message 220 in accordance with the conditions and limitations set forth in the FCT message 220. An example method illustrating the process performed by the FCT engine smart contract 251 is described further below with respect to FIG. 5.

It should be noted that various disclosed embodiments are described with respect to the FCT engine smart contract 251 being configured to perform functions both related to vault management (i.e., management of the on-chain wallets 252) as well as to checking limitations on and executing FCTs, but that the disclosed embodiments are not limited to a single smart contract including instructions for executing both of these functions. In various disclosed embodiments, a first FCT engine smart contract may include instructions for checking limitations on and executing FCTs, and a third vaults factory smart contract may include instructions for managing vaults including respective sets of on-chain wallets. Management of such vaults may include, but is not limited to, creating, assigning, or otherwise controlling vaults and the respective on-chain wallets included among those vaults.

In an embodiment, each of the on-chain wallets 252 is a smart contract including instructions for implementing wallet functionality. To this end, each of the on-chain wallets may have a virtual address, stores assets (e.g., by storing data used to access assets), both, and the like. Each of the on-chain wallets includes instructions for performing functions such as, but not limited to, holding assets, executing transactions according to rules, and the like. More specifically, each of the on-chain wallets may have permissions for requesting recording of transactions by one or more fourth records smart contracts (RSCs) 253.

To this end, the on-chain wallets 252 are configured to execute transactions of the FCT via one or more records smart contracts 253. To this end, the on-chain wallets 252 are responsible for configuring one or more of the records smart contracts 253 by setting rules for each of the records smart contracts 253 in order to cause the records smart contracts 253 to record data reflecting actions taken pursuant to the FCTs. Each records smart contract 253 is configured to enforce its respective rules set by the on-chain wallets 252, and may further be configured to hold funds (e.g., cryptocurrency). Non-limiting example services of the records smart contracts 253 may include smart contracts compatible with methods used by various public services such as decentralized finance (DeFI) services (e.g., Ethereum), Metaverse services, Ethereum Request for Comment (ERC), combinations thereof, and the like.

Accordingly, using the on-chain wallets 252 to manage the records smart contracts 253 allows for blockchain transactions that may include checking conditions defined using data originating from other services uploaded to a blockchain on which the on-chain wallets 252 are deployed. As a non-limiting example, actions defined in a given FCT message 220 may require transferring Ethereum Ether to pay transaction fees on two different platforms, and the FCT may be conditioned such that the price of Ether on each of the platforms may need to meet a threshold or other requirement before any of the actions of the FCT are executed.

The FCT engine smart contract 251 is further configured to validate the signature of the FCT message 220. Additionally, the FCT engine smart contract 251 is configured to check the conditions of the FCT message 220 once the signature is validated, for example using one or more comparison functions (CF) 254. To this end, the FCT engine smart contract 251 may view data accessible via the services of the records smart contracts 253 in order to retrieve data used for comparisons in order to check whether conditions of a given FCT have been met. Non-limiting example comparison functions 254 include SelectionCriteria functions such as GT, EQ, LT, and the like.

Additionally, when the conditions of a FCT (e.g., the conditions 131, FIG. 1) include external conditions, the records smart contracts 253 may include instructions for receiving external data (e.g., weather data, sports result data, etc.), for storing that external data on the blockchain, and for accessing the external data when called (e.g., by the vaults factory 251). To this end, in some embodiments, additional security measures may be provided in order to further ensure the accuracy of the data uploaded to the blockchain (and, consequently, the data upon which FCT conditions are checked). In such embodiments, a voting mechanism may be implemented. For example, a voting mechanism may require a certain number (e.g., 3) or proportion (e.g., 3/5) of trusted nodes (e.g., systems operated by trusted entities, not shown) to agree about the external data to be added before that external data is stored on the blockchain 250. This ensures that the FCTs are conditioned on accurate data even when at least a portion of the data originates outside of the blockchain 250.

It should be noted that the FCT messages are shown as being stored on a decentralized storage merely for example purposes, and that the FCT messages may be stored on a centralized storage pending upload to a blockchain in accordance with at least some disclosed embodiments. As a non-limiting example, the storage on which the FCT messages are temporarily stored may be realized as a centralized server without departing from the scope of the disclosure. It is also noted that a single set of on-chain wallets 252 is depicted in FIG. 2 for simplicity purposes, but that multiple sets of on-chain wallets (each set of on-chain wallets also referred to as a vault) may be utilized in accordance with various disclosed embodiments. Each set of on-chain wallets may be responsible for executing a respective part of a FCT via a respective blockchain platform.

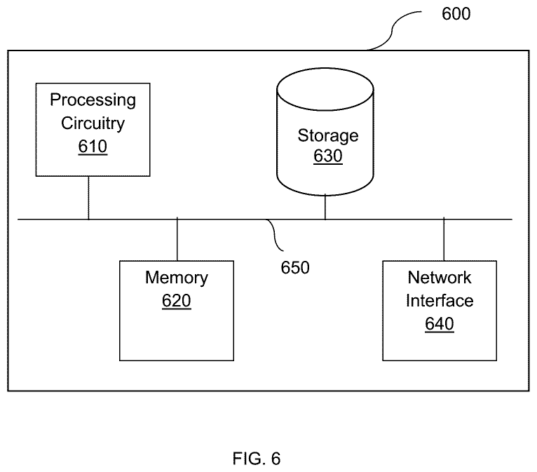

FIG. 3 is a flowchart 300 illustrating a method for creating a future conditional transaction (FCT) according to an embodiment. In an embodiment, the method of FIG. 3 may be operated on a user device (e.g., a device operated by the user 210, FIG. 2). An example hardware layer which may be utilized to implement instructions for performing the method of FIG. 3 is described further below with respect to FIG. 6.

At S310, user inputs defining parameters for a FCT are received. The parameters defined by the user inputs may include, but are not limited to, conditions (e.g., the conditions 131), actions to be performed (e.g., the actions 132), limitations on uploading the FCT (e.g., the limits 133), combinations thereof, and the like. In accordance with various embodiments, a user may be provided with a user interface allowing for selection of different types of parameters, inputting values for different parameters, both, and the like. The user inputs may be analyzed and translated into a FCT message format as discussed above.

At S320, the FCT message is created based on the user inputs. The FCT message may be created using FCT message creation rules defining predetermined relationships between user inputs and contents of FCT messages. The FCT message defines the conditions as well as actions to be performed via one or more blockchain platforms. In an embodiment, the FCT message is in a blockchain-agnostic format, and the FCT message may be translated into blockchain platform-specific languages in order to allow actions to be performed on respective blockchain platforms.

At S330, the FCT message is signed. The signing may be performed in accordance with signing techniques known to persons having ordinary skill in the art, and allow for verifying the authenticity of the FCT message, for example, when the FCT message is to be uploaded to a blockchain in order to execute the FCT.

At S340, the FCT message is sent to a storage (e.g., the decentralized storage 230, FIG. 2), pending activation by one or more activators (e.g., the activators 240). The activators 240 may check conditions on uploading defined as limits in the FCT message in order to determine when to activate the respective FCT by uploading the FCT message to a blockchain. To this end, the activators 240 may store copies of a FCT engine smart contract including instructions for performing such activities as discussed above.

FIG. 4 is a flowchart 400 illustrating a method for activating a future conditional transaction according to an embodiment. In an embodiment, the method of FIG. 4 may be performed by one of the activators 140 or 240, FIGS. 1-2. The method of FIG. 4 may be performed through execution of a FCT engine smart contract via the activators. An example hardware layer which may be utilized to implement instructions for performing the method of FIG. 4 is described further below with respect to FIG. 6.

At S410, limits on uploading a FCT are monitored with respect to one or more data sources. In an embodiment, S410 includes comparing data stored in the data sources to the conditions defined in an FCT message in order to determine when each of the conditions have been met. The data sources may include, but are not limited to, decentralized data structures (e.g., blockchains), centralized data structures (e.g., databases), both, and the like.

At S420, it is identified that all conditions defined in the limits of the FCT have been met. When all conditions on uploading the FCT have been met, it is determined that the FCT message for the FCT should be activated by uploading the FCT message to a blockchain on which a first FCT engine smart contract is stored. As noted herein, the FCT engine smart contract is a smart contract having instructions to check limitations on executing FCTs and to execute FCTs whose limitations have been met via a set of on-chain wallets, where each set of on-chain wallets is a set of smart contracts having wallet functionality that enables the on-chain wallets of each set of on-chain wallets to execute transactions via one or more blockchains.

At S430, when all conditions on uploading the FCT have been met, the FCT message is uploaded to the blockchain on which the FCT engine smart contract is stored. In an embodiment, S430 includes retrieving a copy of the FCT message from a storage (e.g., the decentralized storage 230).

FIG. 5 is a flowchart 500 illustrating a method for executing a future conditional transaction according to an embodiment. In an embodiment, the method of FIG. 5 may be performed by a node storing the blockchain 250, FIG. 2. More specifically, the node performing the flowchart 500 executes a smart contract acting as a FCT engine (e.g., the FCT engine smart contract 251, FIG. 2). An example hardware layer which may be utilized to implement instructions for performing the method of FIG. 4 is described further below with respect to FIG. 6.

At S510, a FCT message uploaded to a blockchain is identified. When the method of FIG. 5 is performed by a FCT engine (e.g., the FCT engine smart contract 251), the identified FCT message is identified on the same blockchain where the FCT engine is stored.

At S520, a signature of the identified FCT message is validated. In an embodiment, S520 may include comparing the signature of the FCT message to a known signature of the user who signed the FCT message.

At S530, the FCT message is parsed. As noted above, the FCT message may be written in a blockchain platform-agnostic format. Rules for parsing the FCT message according to that format may be applied in order to parse the conditions and actions defined therein. In various embodiments, S530 may further include identifying the blockchain platforms on which actions are to be executed.

At S540, a set of on-chain wallets is assigned to the FCT represented by the parsed FCT message. Each on-chain wallet is a smart contract stored on the same blockchain as the FCT engine smart contract. The assigned set of on-chain wallets may be a previously created set of on-chain wallets, or S540 may include creating the set of on-chain wallets to be assigned to the FCT. Each on-chain wallet is configured to perform one or more wallet functions, which in turn allows each on-chain wallet to access one or more other blockchains in order to execute transactions. The assigned set of on-chain wallets is selected such that the assigned set of on-chain wallets includes on-chain wallets for any blockchain platforms needed to execute the actions defined in the FCT message.

At S550, conditions defined for the FCT are checked. In an embodiment, S540 includes accessing data stored on the blockchain to which the FCT was uploaded. As noted above, the FCT engine may be configured to utilize sets of on-chain wallets having wallet functionality including permissions to request data from one or more records smart contracts (e.g., the RSCs 253) stored on the blockchain to which the FCT message is uploaded. To this end, S550 may include commanding one or more records smart contracts to retrieve data and checking the conditions for executing the FCT based on the retrieved data, for example via an assigned set of on-chain wallets.

At S560, the FCT is executed via its respective assigned set of on-chain wallets when the conditions for executing the FCT have been met. As noted above, the method may be performed by a FCT engine, which is a smart contract configured to perform wallet functions via each set of on-chain wallets. To this end, the FCT engine has computer instructions for issuing commands to the on-chain wallets. Such commands may include commands to request recording of transactions on blockchains. When a set of on-chain wallets receives commands from the FCT engine to execute a FCT, each action of the FCT is performed via a respective on-chain wallet. More specifically, each on-chain wallet has permissions to request recording of transactions via records smart contracts stored on the blockchain. The recording of these transactions may be utilized to realize the actions defined in the FCT.

Some non-limiting examples of use cases for the FCTs described herein are now explained. These non-limiting examples are provided for illustrative purposes only in order to demonstrate various benefits which may be realized using various disclosed embodiments.

A FCT may be used to allow for calling a fast swap on a blockchain platform (e.g., a swap of one token for another) while waiting for a lower fee transfer by defining conditions for the FCT that include a cost of actions to be performed.

A FCT may be cancelled (potentially even after the FCT has been signed), for example while the FCT is stored in a decentralized storage pending upload to a blockchain.

A FCT message may define a starting time, an expiration time, or both, in order to set time limits upon execution of the FCT to allow for scheduling transactions for subsequent execution in advance.

In embodiments where activator systems (e.g., the activators 240) are used to upload FCTs to the blockchain, transactions may be uploaded to their respective blockchains even if a wallet of the user who requested the FCT (e.g., the user of the wallet 110 which signed the FCT message of the FCT) is empty or otherwise lacks the funds that would normally be needed to upload a transaction to the appropriate blockchain. To this end, the activators may be or may include wallets containing cryptocurrency which may be utilized to pay any transaction fees. This may be useful, for example, if a user originally has sufficient funds to conduct the transaction but does not have the needed funds in their wallet during the time at which the conditions of the FCT are met.

Since each FCT can function as an atomic transaction including multiple actions that operate as sub-transactions, multiple transfers may be realized via a single transaction, e.g., by recording data causing actions such as transferring cryptocurrency or NFTs bundled in a single transaction to a blockchain. This may allow for minimizing computing resources needed to record transactions, to minimize transaction fees associated with recording transactions (i.e., when there is a fee for each transaction recorded), both, and the like. In at least some embodiments, actions within a given FCT may be conditioned upon the same set of conditions such all actions fail or succeed based on the conditions of the FCT. In other words, the FCTs may be atomic in the sense that either all of its actions are executed, or none of the actions are executed. Moreover, actions may be performed at the same time such that there is no time between checks for actions as reflected in blockchain records.

The FCTs allow for defining a swap action that includes two transfers, where each transfer requires a signature by a respective party to the FCT. Both transfers may be sent via the same FCT.

In at least some embodiments, actions of FCT messages may be defined with respect to variables. As a non-limiting example where a variable is defined in a FCT message for a FCT that involves selling a particular NFT in exchange for cryptocurrency, a variable for transferring the cryptocurrency may include an address of the owner of the NFT. Since the owner of the NFT may change between when the FCT is initially defined and when the FCT is executed (i.e., when the actions involving transferring the NFT and the cryptocurrency are performed via recording on a blockchain), defining the address of the NFT owner as a variable allows for performing the action of transferring the cryptocurrency to an appropriate entity when the FCT is subsequently executed. Given the future nature of the FCT (i.e., the FCT may be defined such that it is recorded on the blockchain at a later time as compared to when the FCT is defined), defining such variables allows for adjusting execution of the FCT accordingly.

Further, since the FCTs may be defined in an atomic fashion such that all actions are performed at the same time upon meeting certain conditions, FCTs may be defined with respect to the same variable such that the FCTs are performed with respect to the same entities, tokens, cryptocurrencies, virtual property items, and the like. When different actions defined with respect to the same variable are performed simultaneously in this fashion, it can be ensured that the actions are performed with respect to the same value of that variable (e.g., to the same address, etc.).

As noted above, FCTs may be linked such that they are conditional upon each other. If-then logic defined between FCTs may be executed in an atomic fashion on a blockchain such that FCTs may be effectively bundled into a mega FCT including conditions and actions, where the actions of a mega FCT include executing sub-FCTs of the mega FCT. The sub-FCTs are executed simultaneously when the conditions defined for the mega FCT are met.

Bundling FCTs into mega FCTs may allow for protecting against sandwich attacks in which an attacker (e.g., via a bot) initiates a trade before the FCT and after the FCT in an attempt to cause an artificial price increase for the FCT. If-then logic may be applied to, for example, prevent a first FCT that is dependent upon a second FCT from being executed if a third FCT (i.e., the first transaction of a potential sandwich attack) has been executed between the first and second FCTs. As another example, FCTs may be linked such that, when a first FCT fails, a second FCT may also fail or may include different actions than it would have if the first FCT had succeeded. Moreover, such linkages may be used to limit orders (e.g., to prevent over ordering), to prevent arbitrage (i.e., the purchase and sale of assets on multiple blockchain platforms simultaneously to exploit a temporary discrepancy in values of those assets), and the like.

FCTs may further be pooled in order to reduce fees needed to conduct transactions. When FCTs are pooled, the cost of uploading fees to transactions via blockchains may be split among user accounts. To this end, FCTs that are linked as sub-FCTs of a mega FCT may be translated into one native transaction on the blockchain and recorded as such a single transaction in order to effectively pool the FCTs and minimize the number of transactions recorded on the blockchain.

Additionally, in accordance with at least some disclosed embodiments, mega FCTs (each of which is defined with respect to multiple FCTs) may be further bundled, i.e., mega FCTs may be linked or otherwise the limitations on recording multiple mega FCTs may be defined such that those limitations are met and the multiple mega FCTs are recorded as a single transaction at the same time. This may further reduce the number of transactions recorded on the blockchain, thereby further reducing computing resources needed for such transactions. Additionally, bundling recording of mega FCTs in this manner may improve stability of the activator systems uploading the mega FCTs to a blockchain, thereby improving the computer performance of these systems.

Because the FCTs may be defined in human-readable language, all FCTs may be human-readable and secured by an appropriate human-readable blockchain standard. This allows users to review the messages used by the smart contracts to execute their FCTs instead of blindly signing a smart contract and without requiring that the user explicitly code the smart contract to set conditions and actions.

FIG. 6 is an example schematic diagram of a hardware layer 600 utilized according to an embodiment. The hardware layer 600 includes a processing circuitry 610 coupled to a memory 620, a storage 630, and a network interface 640. In an embodiment, the components of the hardware layer 600 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform one or more of the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the hardware layer 600 to communicate with other hardware or logical systems over one or more networks. As a non-limiting example where the hardware layer 600 is included in a device operated by the user 210, FIG. 2, the network interface 640 may allow the device of the user 210 to communicate with servers of the decentralized storage 230 in order to store FCT messages. As a non-limiting example where the hardware layer 600 is included in one of the activators 240, FIG. 2, the network interface 640 may allow the activator 240 to communicate with a blockchain platform on which the blockchain 250 is stored. As a non-limiting example where the hardware layer 600 is deployed on one of the nodes storing the blockchain 250 in order to implement the vaults factory 251, FIG. 2, the network interface 640 may allow the node to communicate with the activators 240 and/or other nodes on which the blockchain is stored.

It should be understood that the embodiments described herein are not limited to the specific architecture illustrated in FIG. 6, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for executing future conditional blockchain transactions, comprising:
creating a future conditional transaction (FCT) based on a FCT message, wherein the FCT message includes at least one condition, at least one action to be executed when the at least one condition is met, and at least one limitation on uploading the FCT to a blockchain, wherein the blockchain has stored thereon a first smart contract and a plurality of second smart contracts, wherein each of the plurality of second smart contracts includes instructions for implementing at least one wallet function; and
uploading the FCT to the blockchain based on the at least one limitation, wherein the first smart contract is configured to determine that the at least one condition is met and to execute the at least one action via the plurality of second smart contracts when the at least one condition is met.

2. The method of claim 1, wherein the FCT message is uploaded to the blockchain, wherein the first smart contract is configured to read the FCT message on the blockchain.

3. The method of claim 1, wherein the first smart contract is further configured to validate a signature of the FCT message.

4. The method of claim 1, wherein the first smart contract is further configured to assign at least one second smart contract of the plurality of second smart contracts to the FCT.

5. The method of claim 4, wherein the at least one second smart contract assigned to the FCT is configured to record at least one transaction on the blockchain with respect to the FCT.

6. The method of claim 1, wherein the at least one action is defined with respect to at least one variable, wherein the at least one action is executed based on a value of the at least one variable.

7. The method of claim 1, wherein the FCT is a first FCT, wherein the first FCT defines logic linking the first FCT to a second FCT such that the first FCT is conditional upon the second FCT.

8. The method of claim 7, wherein the first FCT is a first sub-FCT of a plurality of sub-FCTs of the second FCT, wherein the second FCT has at least one condition, wherein the plurality of sub-FCTs are executed simultaneously when the at least one condition of the second FCT is met.

9. The method of claim 8, wherein the plurality of sub-FCTs are translated into a single native transaction, wherein the single native transaction is recorded on the blockchain.

10. A non-transitory computer readable medium having stored thereon instructions for causing a processing circuitry to execute a process, the process comprising:
creating a future conditional transaction (FCT) based on a FCT message, wherein the FCT message includes at least one condition, at least one action to be executed when the at least one condition is met, and at least one limitation on uploading the FCT to a blockchain, wherein the blockchain has stored thereon a first smart contract and a plurality of second smart contracts, wherein each of the plurality of second smart contracts includes instructions for implementing at least one wallet function; and
uploading the FCT to the blockchain based on the at least one limitation, wherein the first smart contract is configured to determine that the at least one condition is met and to execute the at least one action via the plurality of second smart contracts when the at least one condition is met.

11. A system for executing a future conditional blockchain transaction, comprising:
a processing circuitry; and
a memory, the memory containing instructions that, when executed by the processing circuitry, configure the system to:
create a future conditional transaction (FCT) based on a FCT message, wherein the FCT message includes at least one condition, at least one action to be executed when the at least one condition is met, and at least one limitation on uploading the FCT to a blockchain, wherein the blockchain has stored thereon a first smart contract and a plurality of second smart contracts, wherein each of the plurality of second smart contracts includes instructions for implementing at least one wallet function; and
upload the FCT to the blockchain based on the at least one limitation, wherein the first smart contract is configured to determine that the at least one condition is met and to execute the at least one action via the plurality of second smart contracts when the at least one condition is met.

12. The system of claim 11, wherein the FCT message is uploaded to the blockchain, wherein the first smart contract is configured to read the FCT message on the blockchain.

13. The system of claim 11, wherein the first smart contract is further configured to validate a signature of the FCT message.

14. The system of claim 11, wherein the first smart contract is further configured to assign at least one second smart contract of the plurality of second smart contracts to the FCT.

15. The system of claim 14, wherein the at least one second smart contract assigned to the FCT is configured to record at least one transaction on the blockchain with respect to the FCT.

16. The system of claim 11, wherein the at least one action is defined with respect to at least one variable, wherein the at least one action is executed based on a value of the at least one variable.

17. The system of claim 11, wherein the FCT is a first FCT, wherein the first FCT defines logic linking the first FCT to a second FCT such that the first FCT is conditional upon the second FCT.

18. The system of claim 17, wherein the first FCT is a first sub-FCT of a plurality of sub-FCTs of the second FCT, wherein the second FCT has at least one condition, wherein the plurality of sub-FCTs are executed simultaneously when the at least one condition of the second FCT is met.

19. The system of claim 18, wherein the plurality of sub-FCTs are translated into a single native transaction, wherein the single native transaction is recorded on the blockchain.
